(19) United States
(12) Patent Application Publication
(10) Pub. No.: US 2007/0233930 A1
(43) Pub. Date: Oct. 4, 2007

(54) System and method of resizing PCI Express bus widths on-demand

(75) Inventors: James R. Gallagher, Austin, TX (US); David D. Galvin, Austin, TX (US); Binh K. Hua, Austin, TX (US); Sivarama K. Kodukula, Round Rock, TX (US)

Correspondence Address: IBM CORPORATION (VE);C/O VOLEL EMILE, P. O. BOX 162485, AUSTIN, TX, 78716, US

(73) Assignee: International Business Machines Corporation

(21) Appl. No.: 11/375,493

(22) Filed: Mar. 14, 2006

(51) Int. Cl. G06F 13/40

(52) U.S. Cl. 710/307

(57) ABSTRACT

A peripheral component Interconnect (PCI) switch that has at least one control logic device that is capable of changing, on-demand, widths of dedicated buses is provided. The buses are PCI Express buses and thus, are composed of lanes. The control logic device is a lane enable register (LER). Each location in the LER corresponds to a lane of a dedicated bus and is used to enable or disable the corresponding lane. Consequently, widths of dedicated buses are changed by using the switch of the invention to add or subtract one or more lanes from the buses.

### BACKGROUND OF THE INVENTION

1. Technical Field

The present invention is directed generally to Peripheral Component Interconnect (PCI) Express buses. More specifically, the present invention is directed to a system and method of resizing PCI express bus widths on-demand.

2. Description of Related Art

Unlike previous generations of PCI buses, which all use a shared bus architecture, PCI Express uses a point-to-point bus architecture. Accordingly, a dedicated bus is used for data transaction between any two devices on a computer system that uses a PCI Express bus system. The dedicated bus is facilitated by a switch which establishes the point-to-point connection between the communicating devices. Thus, the switch is used as an intermediary device and is physically and logically located between any two devices attached to the computer system.

The switch contains a plurality of ports to facilitate the attachment of the devices to the computer system. A connection between a device and a port of the switch is commonly referred to as a link. Each link is composed of one or more lanes, and each lane is capable of transmitting data at 2.5 Gb/s at a time in both directions at once. Hence, each lane is a full-duplex connection.

A link that is composed of a single lane is called an x1 link. Likewise, a link that is composed of two lanes or four lanes is called an x2 link, or x4 link, respectively. PCI Express supports x1, x2, x4, x8, x12, x16 and x32 links. Thus, a dedicated bus may be 1-lane, 2-lane, 4-lane, 8-lane, 12-lane, 16-lane or 32-lane wide.

Generally, computer users have specific throughput/bandwidth requirements. Knowing so, switch designers have commonly designed PCI Express switches with specific input/output (I/O) port configuration (i.e., switches with ports that are x1-link, or x2-link, or x4-link wide etc. or a combination thereof). This approach can be quite expensive since to satisfy different computer users, multiple versions of a switch may have to be designed. In so doing, different versions of switches may have to be tested and maintained.

Thus, what is needed is an apparatus, system and method of allowing ports of one size (i.e., the largest size that a switch designer is willing to support) to be used in a system and for allowing dedicated buses to be sized and resized on-demand.

### SUMMARY OF THE INVENTION

The present invention provides a peripheral component Interconnect (PCI) switch that has at least one control logic device that is capable of changing, on-demand, widths of dedicated buses. The control logic device may be located between an I/O device and the switch.

In a particular embodiment, the control logic device is a lane enable register (LER). Each location in the LER corresponds to a lane of the dedicated bus and is used to enable or disable its corresponding lane. Consequently, the bandwidth of a dedicated bus is changed by using the switch of the invention to add or subtract one or more lanes from the dedicated bus.

Therefore, a computer system that uses the switch of the present invention to establish a dedicated bus between any two devices attached thereto is enabled to allow the width of the dedicated bus to be changed on-demand. In an embodiment, the width of a dedicated bus may be reduced to allow for another dedicated bus to be used simultaneously in the system. Thus, the switch may allow for a plurality of dedicated buses to be used simultaneously.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1a illustrates a computer system with a prior art PCI Express bus system.

FIG. 1b illustrates an exemplary computer system with a PCI Express bus system in accordance with the present invention.

FIG. 2a depicts data transaction through an x1 link.

FIG. 2b depicts data transaction through an x4 link.

FIG. 3 is an exemplary logic for a HW control register.

FIG. 4 is a flowchart of a process that may be used by a software program to automatically vary the bandwidth of a link.

### DETAILED DESCRIPTION OF THE PREFERRED EMBODIMENT

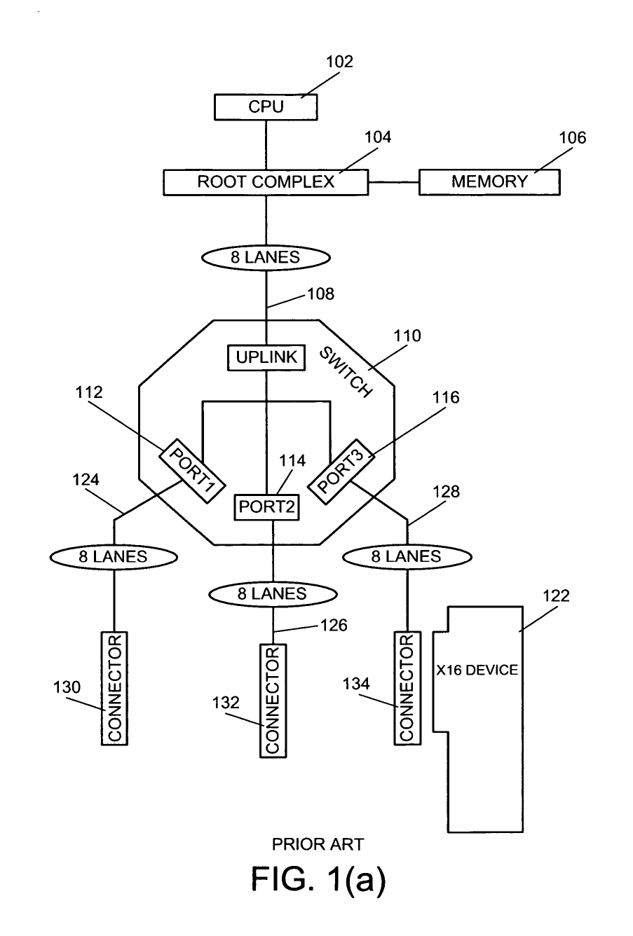

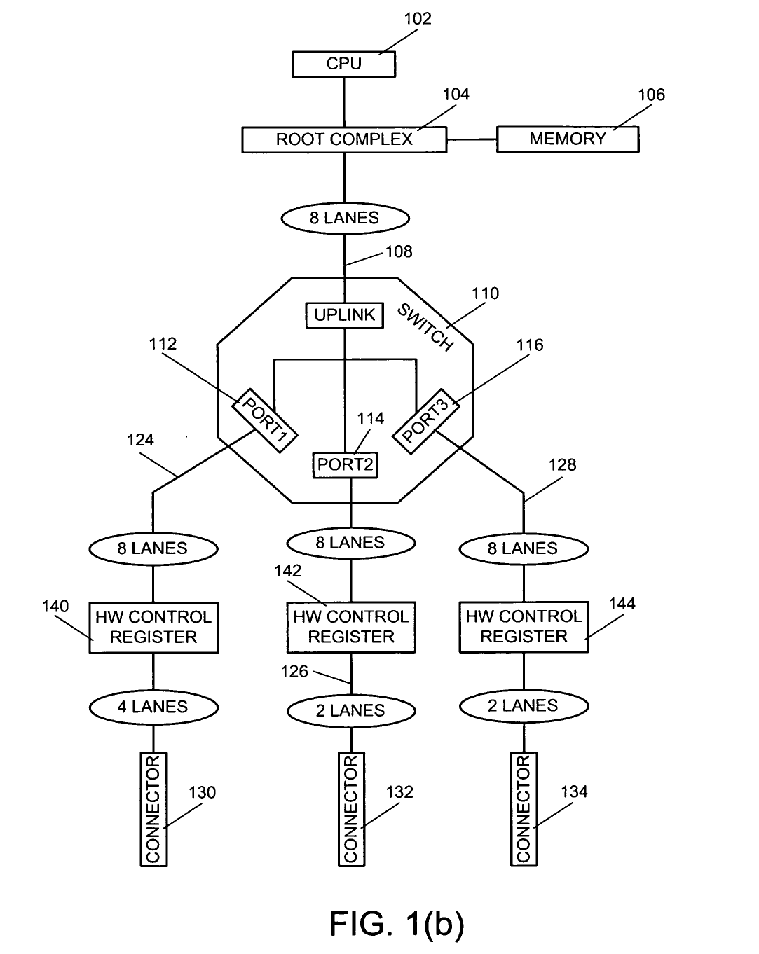

Turning to the figures, FIG. 1a illustrates a computer system with a prior art PCI Express bus system. The computer system includes a CPU 102 and a memory 106 (i.e., RAM) connected to a root complex 104. Also connected to the root complex 104 is a PCI Express switch 110 via an uplink bus 108.

The root complex 104 is similar to a host bridge in a PCI system. That is, the root complex 104 generates transaction requests on behalf of the CPU 102. Root complex functionality may be implemented as a discrete device, or may be integrated within a processor. A root complex may contain more than one PCI Express port and multiple switch devices can be connected to the ports or cascaded from one or more ports.

In any event, the switch 110 has three ports (port 1 112, port 2 114 and port 3 116) to which are attached three connectors (connectors 130, 132 and 134). Specifically, connector 130 is attached to port 1 112 via link 124, connector 132 is attached to port 2 114 via link 126 and connector 134 is attached to port 3 116 through link 128.

Attached to connector 134 is a device (e.g., an adapter) 122. This device 122 uses link 128 to transact data with any other device on the computer system. But note that while link 128 is 8-lane wide, the device 122 is an x16 device (i.e., the device can use 16 lanes to transact data). A link training and initialization feature available in PCI Express bus architecture allows for the device 122 to throttle down to 8 lanes when transacting data.

Specifically, according to the PCI Express Base Specification, which may be obtained from PCI-SIG at www.pcisig.com, at startup, a PCI Express device has to negotiate with a switch to determine the maximum number of lanes that its link can consist of. This link width negotiation depends on the maximum width of the link itself (i.e., the actual number of physical signal pairs that the link consists of), on the width of the connector to which the device is attached, and the width of the device itself.

Since the device 122 is an x16 device, it needs to be plugged into a connector that supports at least 16 lanes. If the connector has fewer than 16 lanes, then it will not have enough contacts to understand all of the signals coming out of the device 122. If it supports more, then the extra lanes may be ignored. Nonetheless, since 8 lanes is the maximum number of lanes that the relevant devices (i.e., connector 134, link 128 and device 122) have in common then the link 128 will be an x8 link.

Suppose the computer system in FIG. 1a is a server that is logically partitioned (LPAR) into two systems (i.e., two LPARs). Suppose further that each LPAR is leased by a different company with expectations to share the I/O bandwidth equally. Moreover, suppose that LPAR 1 has one slot (e.g., connector 130) assigned to it and LPAR 2 has two slots (e.g., connectors 132 and 134) assigned thereto. Lastly, suppose attached to connector 130 is a 10 Gb Ethernet adapter and attached to connectors 132 and 134 each is a 1 Gb Ethernet adapter. In this scenario, the entire width of the uplink 108 is used whenever any one of the adapters is exchanging data with either the processor 102 or the memory 106. In such a case, it is conceivable to assume that the company with the 10 Gb Ethernet adapter will consume more bandwidth than the company with the two 1 Gb Ethernet adapters.

However, if the uplink bus 108 can be subdivided such that all three adapters can transact data at the same time, then the two companies can share the LPAR system more equitably. The present invention provides a method by which the uplink 108 may be subdivided.

FIG. 1b illustrates an exemplary computer system in accordance with the present invention. As can be seen, FIG. 1b is similar to FIG. 1a except that it contains three additional devices (i.e., hardware (HW) control registers 140, 142 and 144) and does not contain the device 122. The HW control registers 140, 142 and 144 may be used to size and resize the width of the links.

For example, each HW control register may be as large as the highest number of lanes supported in the PCI Express bus architecture (i.e., 32-bit long) but should not be less than the number of lanes that a switch manufacturer is willing to support (although it may). Let us suppose that the switch manufacturer is willing to support x8 links and the HW control registers are 8-bit long. Each bit will correspond to a supported lane. In this case, a HW register value may be used to control the number of effective lanes that comprises a link. For instance, if a zero (0) bit at a location of a HW control register indicates that the corresponding lane connection is opened and a one (1) bit indicates that it is closed, then a value of 11110000, for example, in a register indicates an x4 link.

As mentioned before, at startup, each PCI Express device in the system will negotiate with the switch 110 to determine the maximum number of lanes that its link can consist of. In this case, this link width negotiation will depend on the maximum width of the link, which in this case depends on the number of locations in a respective HW control register that contains a one-bit.

Thus, if a user (e.g., a system administrator) enters a one-bit at four locations in HW control register 140 as in the example above, and a one-bit at two locations in HW control registers 142 and 144 (e.g., 00001100 and 00000011 in HW control registers 142 and 144, respectively) the uplink 108 will effectively be divided in three upon restart.

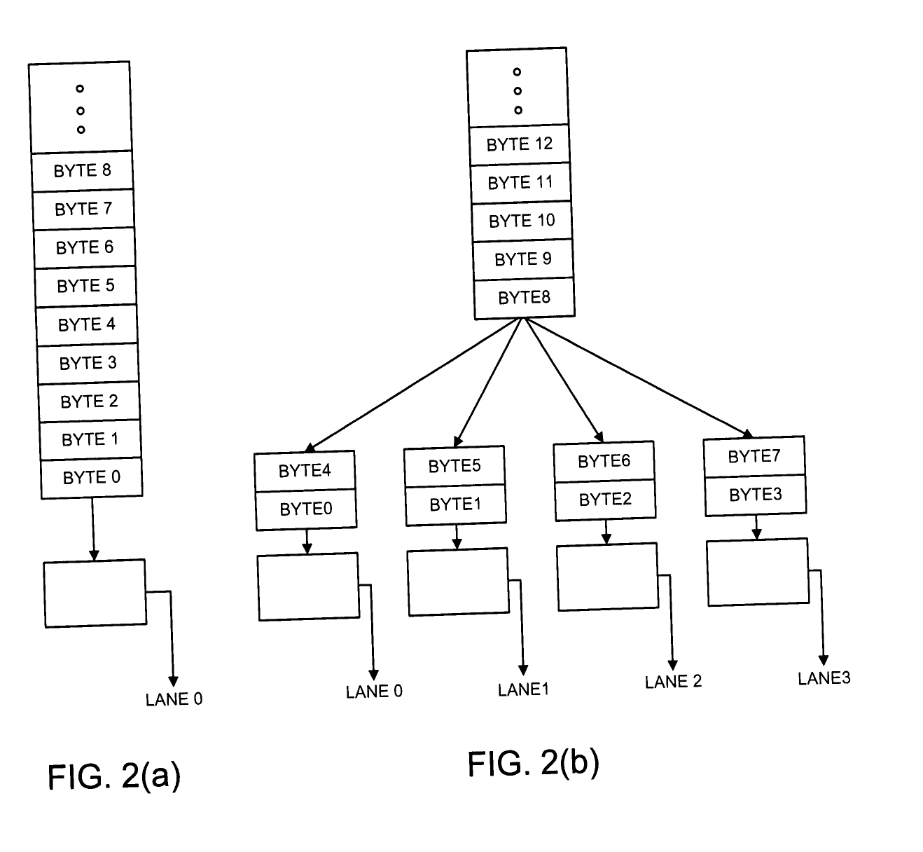

To illustrate, PCI Express uses a packet-based protocol to forward data to and from a device. The data is transferred in bytes. When a link contains only one lane, data is transferred as shown in FIG. 2a. When a link contains more than one lane, the data bytes are striped across the lanes. Thus, if the link is an x4 link, the data may be transferred as shown in FIG. 2b.

In the present invention, since the link 124 will be an x4 link, only 4 lanes of the uplink 108 will be used when data is being transacted between CPU 102, for example, and the 10 Gb Ethernet adapter that would be attached to connector 130. Likewise, only two lanes of the uplink 108 will be used when data is being transacted between the CPU 102 and/or memory 106 and each one of the 1 Gb Ethernet adapter that would be attached to connectors 132 and 134.

Consequently if needed, the switch 110 may open up three simultaneous direct and private communications links between the CPU 102 and/or memory 106 and the Ethernet adapters attached to connectors 130, 132 and 134: an x4 link and two x2 links. The x4 link will be used to transact data between the 10 Gb Ethernet adapter and the CPU 102 or memory 106 while the x2 links will be used to transact data between the 1 Gb Ethernet adapters and the CPU 102 and/or memory 106.

It should be noted that although the one-bits are shown to be entered at different locations in HW control registers 140, 142 and 144, they need not be. It is perfectly within the realm of the invention for 11110000, 11000000, 11000000, for example, to be entered in HW control registers 140, 142 and 144, respectively. Thus, the values used above are only for illustrative purposes.

It should also be noted that a system administrator need not manually enter the values into the HW control registers, an application program may do so automatically. The application program may be a program that is specifically designed to do so or a program that is transacting data on the system.

In the example above, the invention was used for throughput balancing; however, the invention may also be used for on-demand throughputs. For instance, suppose the company that has the 10 Gb Ethernet adapter has a varied throughput requirement. Specifically, suppose during the daytime the company handles transaction processing and at night the company backs its data up. Suppose further that transaction processing only requires a 2.5 Gb/s or less throughput while it is more efficient to backup the data at 10 Gb/s. A value may be entered into HW control adapter 140 that will allow for only an x1 link to be assigned to the company during daytime hours (e.g., 6.00 AM to 6.00 PM) and another value may be used that will allow for an x4 link or greater to be assigned to the company at night (e.g., 6.00 PM to 6.00 AM). Thus, if the company's lease payment is structured on actual bandwidth used, the company may save money as it will only pay for bandwidth that it actually uses instead of for bandwidth that is available for its use.

As can be surmised, the invention provides a number of advantages. For example, the invention allows users and/or application programs to pick and choose, on-demand, the number of active lanes in a link. This user-level customization allows for switch manufacturers to reduce the number of machine types/models offered and supported in the field. Further, the invention provides flexibility to achieve optimal performance per PCI Express connection for existing I/O load as well as for future I/O additions to the system. System administrators may manage I/O bandwidths optimally based on workload and priorities. Thus, as new adapters are introduced, I/O bandwidths can be reconfigured based on new I/O configuration requirements.

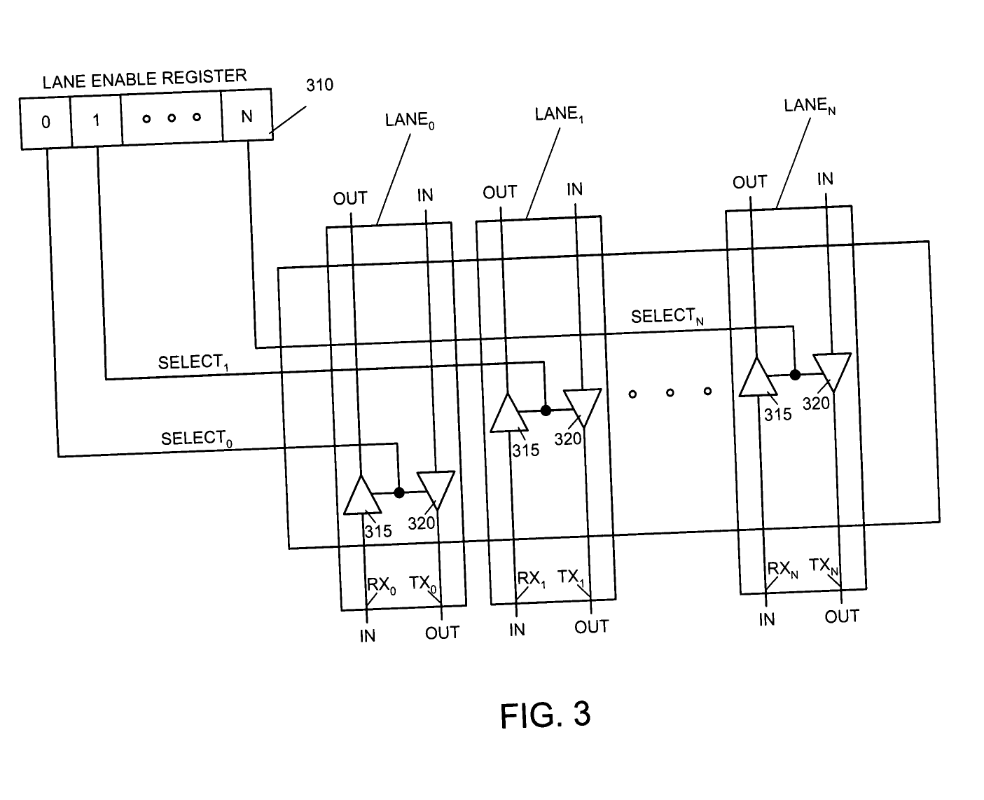

FIG. 3 is an exemplary logic circuit of a HW control register. The logic circuit contains a lane enable register (LER) 310 that has M locations, where N+1=M<=32. As mentioned before, each lane is a full-duplex connection. Thus, each location in the LER 310 is connected to both a receive line (see RX₀, RX₁, . . . , RX_{N}) and a transmit line (see TX₀, TX₁, . . . , TX_{N}) of a lane (see lane₀, lane₁, . . . , lane_{N}) via an associated tristate driver pair 315 and 320. Note that the lines are labeled “RXᵢ” and “TXᵢ”, where 0<=i<=N, in respect to the switch 110 (see FIG. 1b).

As is well known in the art, a tristate driver has an input for receiving input signals, an output for outputting the received input signals and a select line for enablement. When the select line is asserted (e.g., when a “1” is entered at a location in the LER 310), the tristate driver pair 315 and 320 associated with that location will output the signal at their input. When the select line is not asserted (e.g., when a “0” is entered at a location in the LER 310), the output of the associated tristate driver pair floats. Floating a tristate driver output is also referred to as tristating the driver where the driver goes into a high-impedance state. In that state, the driver effectively acts as an open circuit. Thus, when a zero (0) is entered at a location of a HW control register of the present invention, the corresponding lane connection is opened and when a one (1) is entered thereat, the corresponding lane is closed allowing for data to flow through.

It is worth pointing out that although tristate drivers are used to implement the invention, the invention is not thus restricted. There are plenty of other devices that may be used instead of the tristate drivers. For example, “open collector” devices may easily be used instead. Hence the use of the tristate drivers is for illustrative purposes only.

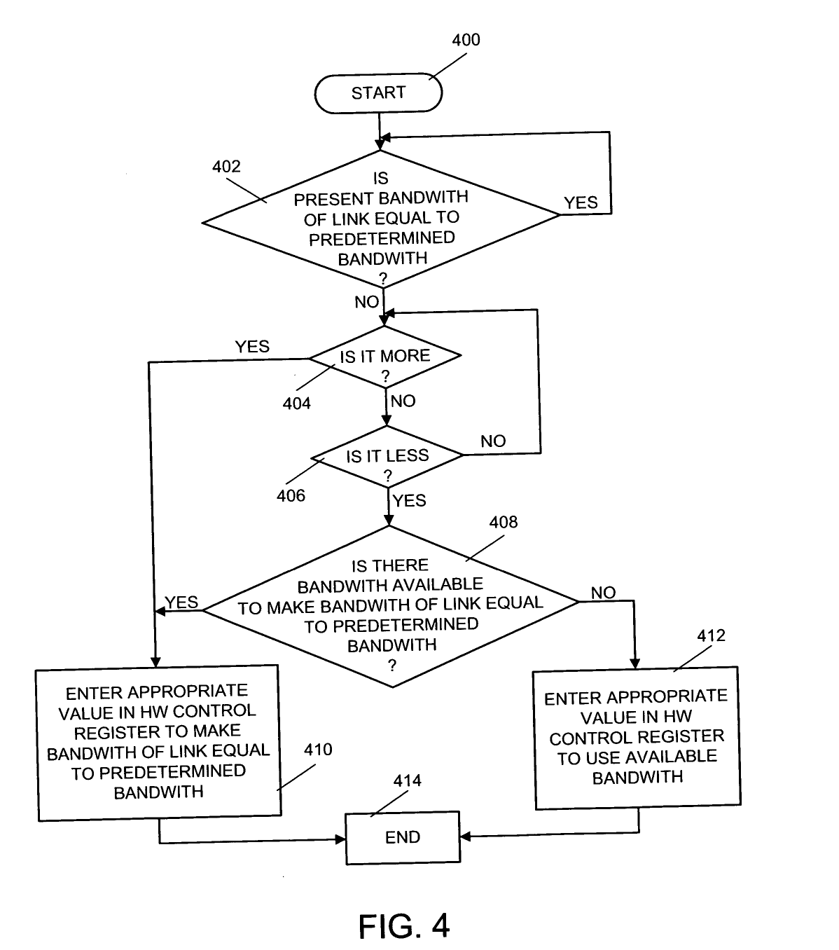

FIG. 4 is a flowchart of a process that may be used by a software program to automatically vary the bandwidth of a link. The process starts when the software program is instantiated (step 400). Then a check is made to determine whether the present bandwidth of the link is equal to a predetermined bandwidth (step 402). The predetermined bandwidth may be an optimal bandwidth that is needed for the software to transact data or a bandwidth that may have been indicated by the user.

If the present bandwidth of the link is not equal to the predetermined bandwidth, a check may be made to see whether it is more than the predetermined bandwidth. If so, the software may enter an appropriate value into the HW control register to make the bandwidth of the link equal to the predetermined bandwidth (steps 404 and 410).

If the present bandwidth of the link is less than the predetermined bandwidth, then another check may be made to determine whether there is enough bandwidth available to make the bandwidth of the link equal to the predetermined bandwidth (steps 406 and 408). If so, the software may enter an appropriate value in the HW control register to make the bandwidth of the link equal to the predetermined bandwidth (step 410) before the process ends (step 414). Otherwise, the software may enter a value in the HW control register that will allow all the available bandwidth to be used (step 412) before the process ends (step 414).

As mentioned before, upon termination of the execution of the process, the circuit may restart in order for the change in bandwidth to take effect.

The process can take the form of a computer program product accessible from a computer-usable or computer-readable medium providing program code for use by or in connection with a computer or any other instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and Digital Video/Versatile Disk (DVD).

Note that for total automation, a configuration profile may be used to have the process run at times when particular bandwidths are needed. Obviously, different versions of the process that contain different predetermined bandwidths may be used in the configuration profile.

The description of the present invention has been presented for purposes of illustration and description, and is not intended to be exhaustive or limited to the invention in the form disclosed. Many modifications and variations will be apparent to those of ordinary skill in the art. For example, other user interfaces may be employed to carry out the invention. The embodiment was chosen and described in order to best explain the principles of the invention, the practical application, and to enable others of ordinary skill in the art to understand the invention for various embodiments with various modifications as are suited to the particular use contemplated.

What is claimed is:

1. A peripheral component Interconnect (PCI) switch for establishing a connection between a first device and a second device on a computer system, the connection having a number of lanes allocated thereto, the PCI switch comprising:
a control logic device for changing, on-demand, the number of lanes allocated to the connection.

2. The PCI switch of claim 1 wherein the control logic is located between the first device and the switch.

3. The PCI switch of claim 1 wherein the number of lanes is changed by adding or subtracting one or more lanes from the connection.

4. The PCI switch of claim 3 wherein the control logic is a lane enable register (LER), each location in the LER corresponding to a lane of the connection and being able to enable or disable the corresponding lane.

5. The PCI switch of claim 4 wherein a value is entered in each location of the LER to enable or disable a corresponding lane.

6. A computer system comprising:
a switch for connecting a set of two devices attached to the computer system for data transaction, the two devices being connected to each other by a bus having a first width; and
control logic for changing, on-demand, the first width to a second width.

7. The computer system of claim 6 wherein the switch connects another set of two devices attached to the computer system for data transaction, the other set of two devices being connected to each other by another bus having a third width that can be changed, on demand, to a width by control logic, both buses being used simultaneously for transacting data.

8. The computer system of claim 6 wherein the bus includes at least one lane linking the two devices.

9. The computer system of claim 8 wherein the control logic is used to add at least one lane to the bus or to subtract at least one lane from the bus, if the bus has more than one lane, to change the width of the bus.

10. The computer system of claim 8 wherein the control logic is a lane enable register (LER) located between the two devices, each location in the LER corresponding to a lane of the bus and being able to enable or disable corresponding lanes.

11. The computer system of claim 10 wherein a value is entered in each location of the LER to enable or disable a corresponding lane.

12. The computer system of claim 11 wherein the value is entered by a user.

13. The computer system of claim 11 wherein the value is entered automatically by an application program.

14. The computer system of claim 13 wherein the application program is a program that is transacting data.

15. The computer system of claim 13 wherein the application program is a program that is designed to change the bus bandwidth at specific times.

16. A method of automatically varying a number of lanes of a peripheral component interconnect (PCI) express bus, the bus for connecting two devices on a computer system to each other for data transaction the method comprising the steps of:
determining whether a present width of the bus is equal to a predetermined width; and
making the present width of the bus equal to the predetermined bandwidth if it is determined that it is not equal to the predetermined bandwidth.

17. The method of claim 16 wherein if the present width of the bus is less than the predetermined width it is ascertained that enough width is available to make the present width of the bus equal to the predetermined width of the bus before the present width of the is made equal to the predetermined width.

18. The method of claim 16 wherein if the present width of the bus is greater than the predetermined width the present width of the bus is made equal to the predetermined width of the bus.

19. The method of claim 16 wherein width of the bus is made of a plurality of lanes, a device is used to enable some of the lanes and to disable some of the lanes to make the present width of the bus equal the predetermined width.

20. The method of claim 19 wherein the device is enabled by a software program to make the present width of the bus equal the predetermined width.
